(19) United States
(12) Patent Application Publication
(10) Pub. No.: US 2002/0180135 A1
(43) Pub. Date: Dec. 5, 2002

(54) Yaeger third hand vise attachment

(76) Inventor: William J. Yaeger, Helena, MT (US)

Correspondence Address: HOOVESTAL & KAKUK, PLLC, 40 W. 14TH ST., P.O. BOX 747, HELENA, MT, 59624, US

(21) Appl. No.: 10/161,889

(22) Filed: Jun. 4, 2002

Related U.S. Application Data
(60) Provisional application No. 60/296,188, filed on Jun. 4, 2001.

(51) Int. Cl. B25B 1/24

(52) U.S. Cl. 269/271

(57) ABSTRACT

The present invention relates to a means for attaching a pair of pliers to a vise for holding a workpiece. The means includes a vise attachment with two attaching units, with each unit having at least one receptacle. Each receptacle being designed and placed in correlation to the other receptacle to hold one handle of a standard pair of pliers. The attachment is attached to the vise and a standard pair of pliers is inserted into the receptacles located on each attaching unit. As the vise jaws are adjusted, the pliers jaws are also adjusted thereby allowing an individual to quickly, securely, and safely hold an article while working on that article with both hands.

### CROSS REFERENCE To RELATED APPLICATIONS

This application claims the benefit of a Provisional Patent Application, Application No. 60/296,188, filing date of Jun. 4, 2001.

### BACKGROUND OF THE INVENTION

Often, when an individual wishes to work with a small or delicate article the individual must hold the article in one hand while working on the article with the other hand. This obviously precludes working on the article with both hands. Usually, using both hands would make the work proceed in a more efficient and effective manner. In other words, often when working on a small or delicate article, the individual needs a “third hand”.

There are products currently on the market that may act as a clamping device or other “third hand” attachment to a vise but these attachments can be cumbersome, expensive, difficult to operate, can be themselves delicate or fragile, or are not suited to holding small and delicate articles. (See, for example, U.S. Pat. Nos. 6,170,813; 5,992,837; and 5,765,822.)

Patent searches using the terms “vise” and “attachment” and “vise” and “pliers” revealed nothing that resembled the disclosed invention. Therefore, there is no vise attachment on the market, or for which a patent has been granted, that allows an individual to quickly, securely, and safely hold a small or delicate article while at the same time allowing the individual to easily re-convert the vise for use in the standard manner.

### BRIEF SUMMARY OF THE INVENTION

The Yaeger Third Hand Vise Attachment overcomes the above-described problems by providing a vise attachment that readily attaches to, and detaches from, the vise and that readily accepts a standard pair of pliers. The pliers then serves as the necessary “third hand” required when working with small or delicate articles.

The Third Hand Vise Attachment operates as follows:

Each vise attachment consists of a set of two attaching units;

Each attaching unit has mounted on it at least one receptacle;

Each receptacle is designed and placed in correlation to the other receptacle to accept one of the two handles of a standard pair of pliers;

As the distance between the vise jaws is adjusted, so the distance between the pliers jaws is adjusted; and

When the individual no longer has a need for the pliers, the individual simply removes the pliers from the receptacles, removes the attachment strips from the vise, and proceeds to use the vise in a normal manner.

A typical use of the vise attachment may include:

Placing an attaching unit on each jaw of the vise;

Adjusting the distance between the vise jaws to allow the placement of a handle of a standard pair of pliers into a receptacle on each attaching unit;

Placing a standard pair of pliers into said receptacles;

Adjusting the vise jaws until the pliers jaws are the proper distance to hold the desired article.

The vise attachment will be of use to anyone who needs to hold a small or delicate article in place while working on that article with both hands.

### BRIEF DESCRIPTION OF THE SEVERAL VIEWS OF THE DRAWINGS

FIGS. 1 through 4 show a standard vise with an exploded view of the vise attachment mounted or otherwise attached to the vise. Specifically:

FIG. 1—shows the attachment units with receptacles mounted laterally and capable of holding the pliers both horizontally and vertically;

FIG. 2—shows the attachment units with receptacles mounted terminally and capable of holding the pliers vertically;

FIG. 3—shows the attachment units with receptacles mounted dorsally and capable of holding the pliers vertically; and

FIG. 4—shows the attachment units with receptacles mounted dorsally and terminally and capable of holding the pliers vertically and horizontally.

### DETAILED DESCRIPTION OF THE INVENTION

With reference now to the Drawings, the preferred embodiment of the new Yaeger Third Hand Vise Attachment comprises a plurality of components. In their broadest context, such components include: two attaching units, each unit including:

a receptacle designed and placed in correlation to the other receptacle to accept one handle of a pair of standard pliers;

each receptacle being securely attached to the attaching unit;

each attaching unit having a means of securely attaching, either actively or passively, to one jaw of a standard vise.

Such components are individually configured and correlated with respect to each other to provide a device used for attaching a pair of pliers to a vise in such a manner that by adjusting the distance between the jaws of the vise you also adjust the distance between the jaws of the pliers. The receptacles may by attached to the attaching units either:

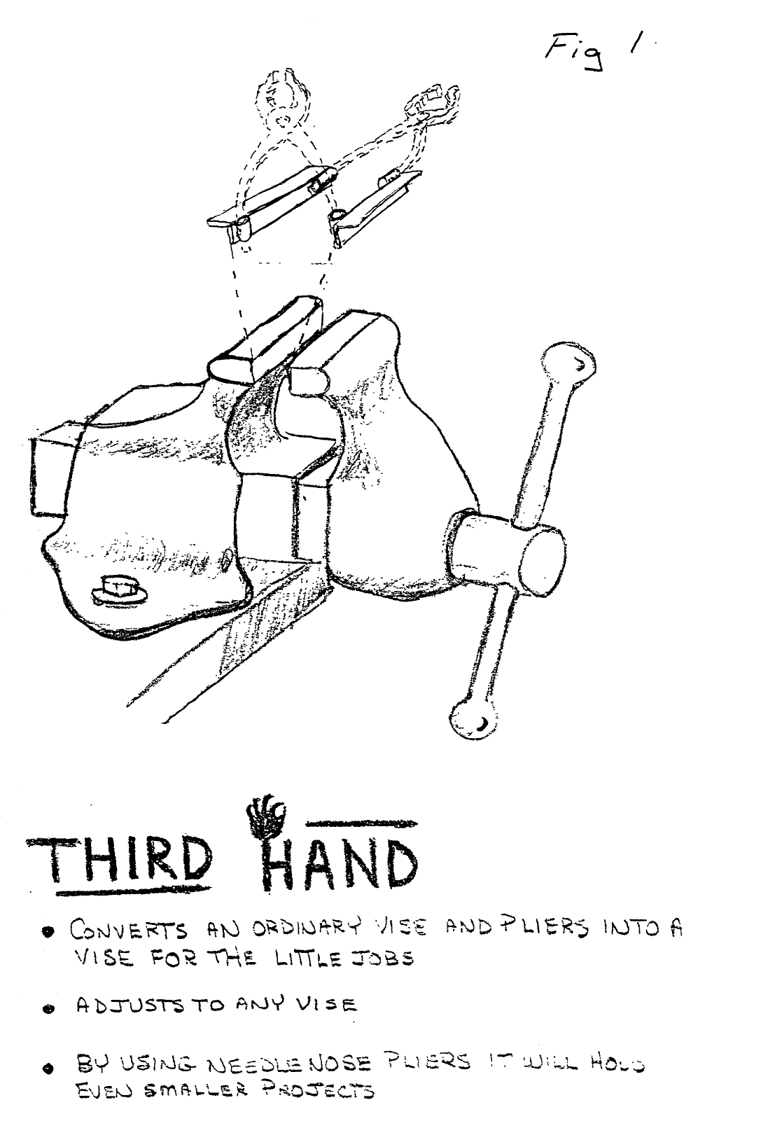

laterally (FIG. 1);

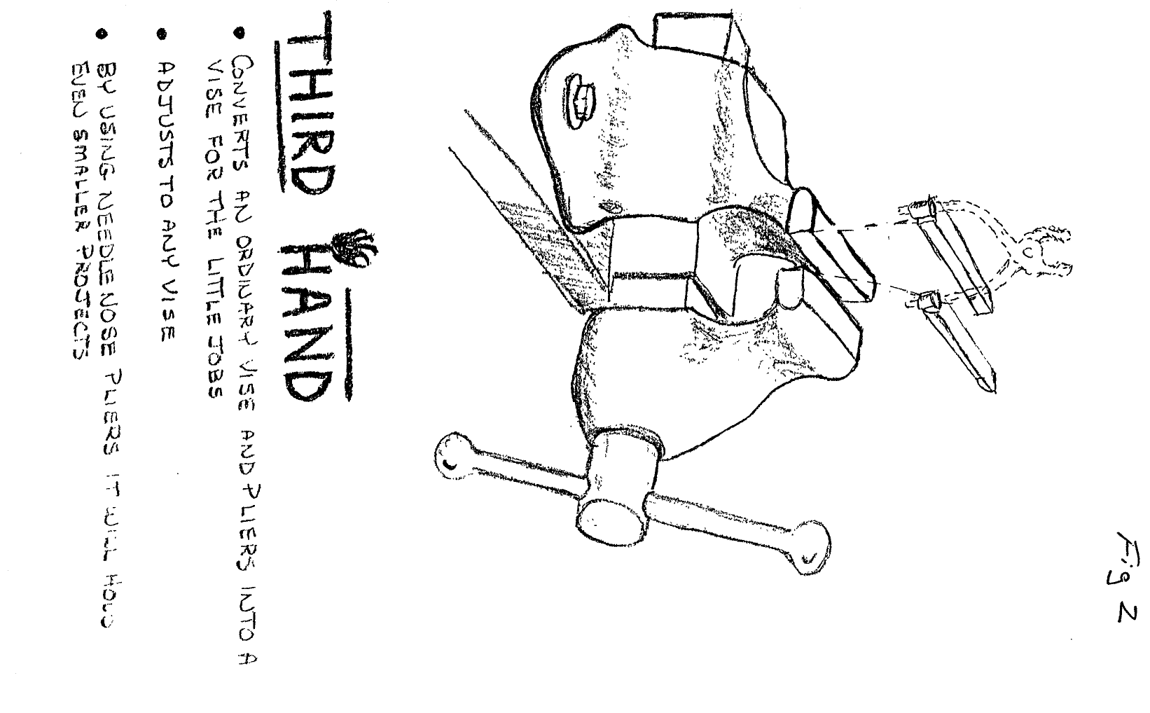

terminally (FIG. 2); or

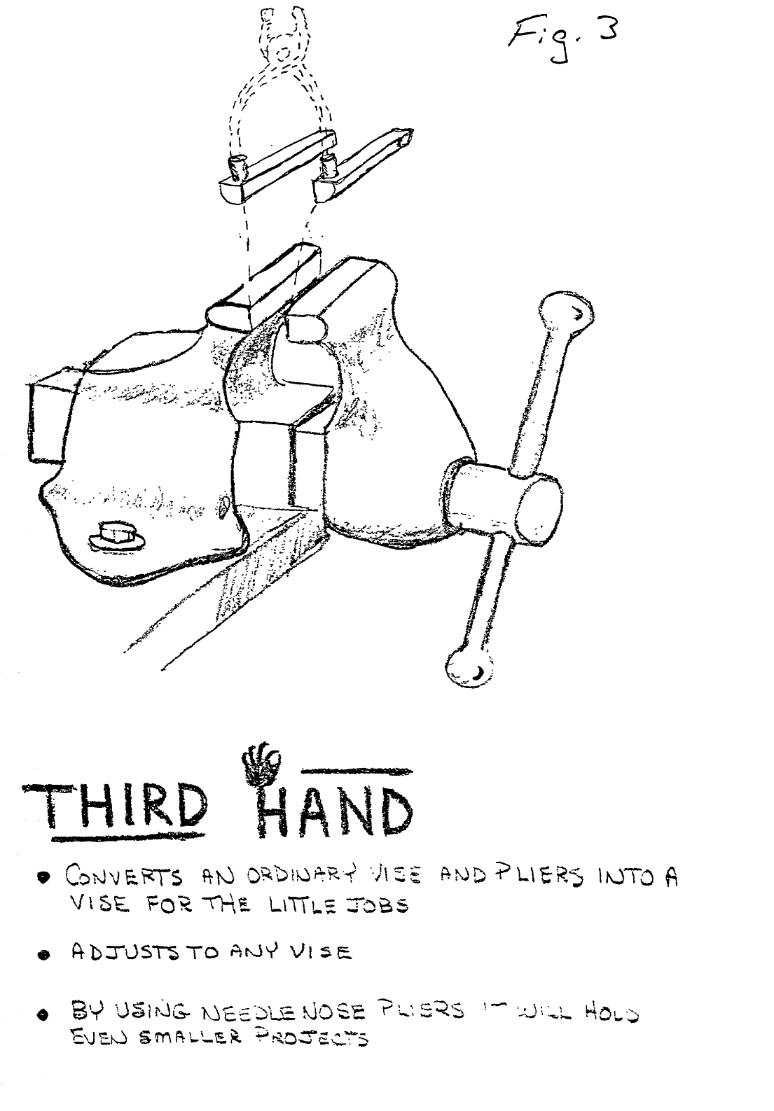

dorsally (FIG. 3).

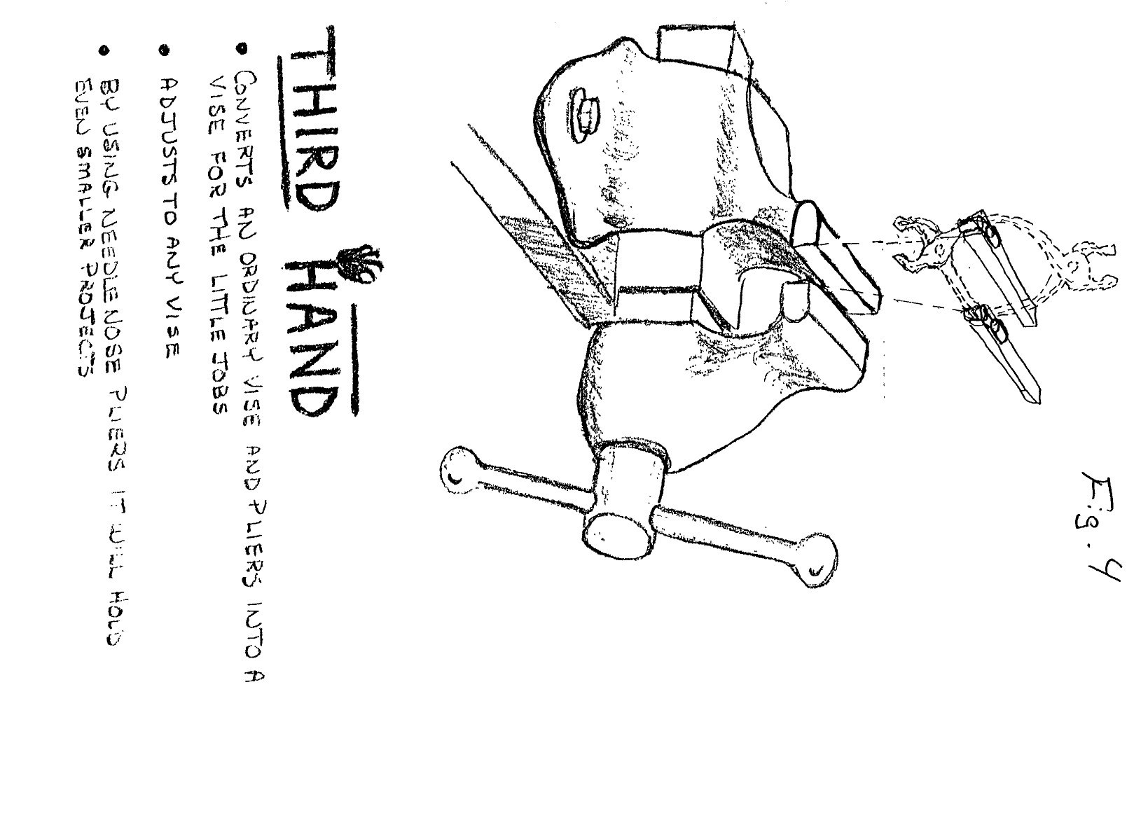

The receptacles may also be attached to the attaching units to allow for either vertical or horizontal attachment of the pliers to the vise. (FIG. 4)

The attaching units are designed to be attached to a multitude of different vise jaw widths using an active mechanism, for example, a screw-type attachment means; a latch-type attachment means; or another adjustable means of attachment, or passively, whereby the pressure from the vise jaws acting against the pliers handles maintains the attaching unit securely in place on the vise.

The attachment is made out of a rigid or otherwise inflexible material, for example metal.

I claim:

1. a means of attaching a pair of pliers to a standard vise utilizing a vise attachment and said vise attachment consisting of two attaching units, each unit:
having a receptacle designed and placed in correlation to the other receptacle to accept one handle of a pair of standard pliers;
having each receptacle being securely attached to the attaching unit; and
having a means, either active or passive, of attaching securely to the vise.

2. the apparatus claimed in claim 1 above where the receptacles are laterally attached to the attaching unit.

3. the apparatus claimed in claim 1 above where the receptacles are terminally attached to the attaching unit.

4. the apparatus claimed in claim 1 above where the receptacles are dorsally attached to the attaching unit.

5. the apparatus claimed in claim 1 above where the specific orientation of the receptacles allows the pliers to be mounted horizontally.

6. the apparatus claimed in claim 1 above where the specific orientation of the receptacles allows the pliers to be mounted vertically.
